(19) United States
(12) Patent Application Publication
(10) Pub. No.: US 2023/0297105 A1
(43) Pub. Date: Sep. 21, 2023

(54) NETWORKED DRONE

(71) Applicant: Paladin Drones Inc., Houston, TX (US)

(72) Inventor: Divyaditya Shrivastava, Houston, TX (US)

(21) Appl. No.: 17/698,941

(22) Filed: Mar. 18, 2022

(51) Int. Cl. G05D 1/00; H04B 7/185; G05D 1/10; B64C 39/02

(52) U.S. Cl. CPC G05D 1/0022; H04B 7/18506; G05D 1/104; G05D 1/0038; B64C 39/024; B64C 2201/027; B64C 2201/127; B64C 2201/146

(57) ABSTRACT

Drone networking can include: obtaining a drone command by communicating with a user of a networked drone via a mobile communication network using internet protocols; and actuating at least one function of the networked drone in response to the drone command.

### BACKGROUND

A drone can be controlled via a radio-frequency communication channel between the drone and a ground-based controller, e.g., an RC controller. Examples of radio-frequency communication channels include 2.5 GHZ and 5.8 GHZ radio frequencies as well as Wi-Fi.

Drone control based on a radio-frequency communication channel can severely limit the range of drone operations. For example, if an airborne drone flies past the radio-frequency range of its ground-based controller or if there is excessive radio-frequency interference during operations, a drone can lose its contact with its controller and crash.

### SUMMARY

In general, in one aspect, the invention relates to a networked drone. The networked drone can include: a command processor that actuates at least one function of the networked drone in response to a drone command; and a network adapter that obtains the drone command by communicating with a user of the networked drone via a mobile communication network using internet protocols.

In general, in another aspect, the invention relates to a method for drone networking. The method can include: obtaining a drone command by communicating with a user of a networked drone via a mobile communication network using internet protocols; and actuating at least one function of the networked drone in response to the drone command.

Other aspects of the invention will be apparent from the following description and the appended claims.

### BRIEF DESCRIPTION OF THE DRAWINGS

Embodiments of the present invention are illustrated by way of example, and not by way of limitation, in the figures of the accompanying drawings and in which like reference numerals refer to similar elements.

FIG. 1 illustrates a networked drone that is controllable by a user via a mobile communication network using internet protocols in one or more embodiments.

FIG. 2 shows an embodiment of a networked drone that streams down a live video via a mobile communication network using internet protocols.

FIG. 3 shows an embodiment of a networked drone that actuates a function of the networked drone in response to a drone command received from a user who is a member of a constellation of users of the networked drone.

FIG. 4 shows a swarm of networked drones that are all controllable by a user from an internet-connected device.

FIG. 5 shows how the networked drones in a swarm of networked drones exchange inter-drone communications via a mobile communication network using internet protocols.

FIG. 6 illustrates how a command processor in one or more embodiments of a networked drone enables a user to control the networked drone via a mobile communication network using internet protocols in one or more embodiments.

FIG. 7 illustrates a method for drone networking in one or more embodiments.

### DETAILED DESCRIPTION

Reference will now be made in detail to the various embodiments of the present disclosure, examples of which are illustrated in the accompanying drawings. Like elements in the various figures are denoted by like reference numerals for consistency. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, have not been described in detail so as not to unnecessarily obscure aspects of the present disclosure.

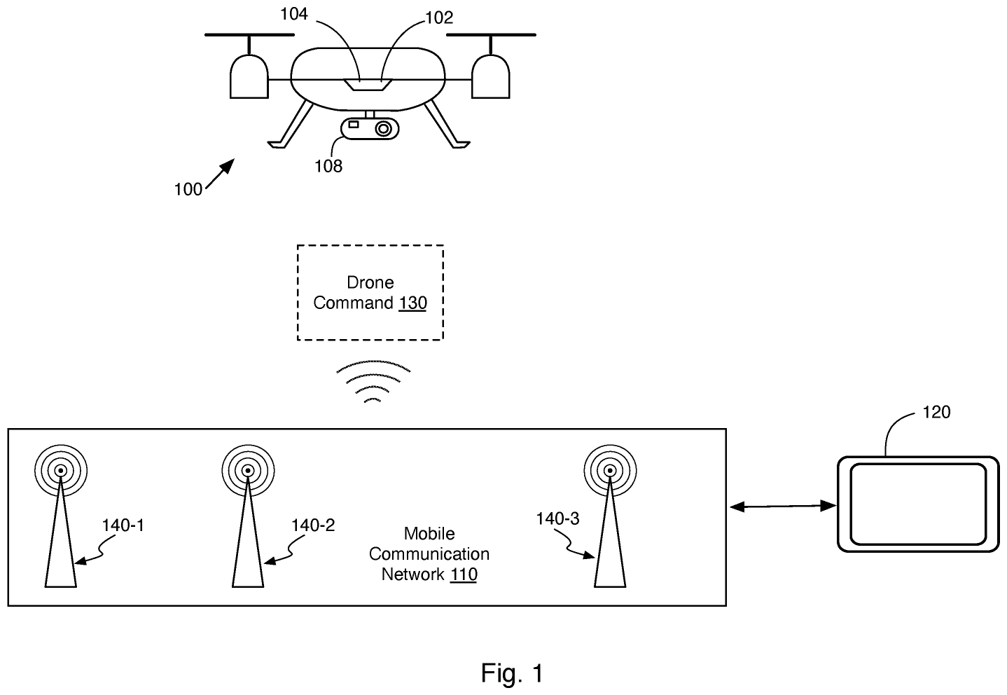

FIG. 1 illustrates a networked drone 100 that is controllable by a user via a mobile communication network 110 using internet protocols in one or more embodiments. The networked drone 100 includes a command processor 102 that actuates a function of the networked drone 100 in response to a drone command 130. The networked drone 100 includes a network adapter 104 that obtains the drone command 130 by communicating with a user of the networked drone 100 via the mobile communication network 110 using internet protocols.

In one or more embodiments, the network adapter 104 obtains the drone command 130 by communicating with an internet-connected device 120 of the user of the networked drone 100 via the mobile communication network 110. In one or more embodiments, the internet-connected device 120 runs a drone app that enables a user to command the networked drone 100 by uploading the drone command 130 to the networked drone 100 via the mobile communication network 110 using internet protocols.

In one or more embodiments, the networked drone 100 and the internet-connected device 120 communicate by establishing one or more Websockets channels via the mobile communication network 110. In one or more other embodiments, the networked drone 100 and the internet-connected device 120 communicate via direct TCP and UDP ports, or other internet protocols.

In one or more alternative embodiments, the internet-connected device 120 communicates the drone command 130 up to the networked drone 100 via a drone server (not shown) that enables the internet-connected device 120 to post communications destined for the networked drone 100 and obtain communications posted by the networked drone 100. In one or more example embodiments, TCP connections, UDP connections, etc. transit through a server and communication between the networked drone 100 and the internet-connected device 120 switches between a server and direct peer to peer communication.

The mobile communication network 110 in one or more embodiments is a cellular network adapted for providing communication coverage for mobile devices such as smartphones, tablets, etc. Examples of cellular network implementations of the mobile communication network 110 include LTE and 5G networks.

The networked drone 100 and the internet-connected device 120 in one or more embodiments can communicate even if geographically located on opposite ends of the planet so long as the networked drone 100 is within range of communication infrastructure, e.g., a set of cell towers 140-1 through 140-3, of the mobile communication network 110.

The networked drone 100 in one or more embodiments includes a data acquisition mechanism 108 for performing one or more data acquisition functions of the networked drone 100. The data acquisition mechanism 108 can include any mechanism that can be carried by an airborne drone. Examples of the data acquisition mechanism 108 in various embodiments include cameras, e.g., still and video cameras, infrared imaging systems, radar, LIDAR, audio sensors, heat sensors, etc. In one or more embodiments, the data acquisition mechanism 108 is a video camera mounted on a gimbaled platform that enables aiming of the video camera and zoom functions for the video camera.

In one or more embodiments, the drone command 130 pertains to a navigation function of the networked drone 100. Examples of navigation functions include commands to steer the networked drone 100, commands to alter the speed or heading of the networked drone 100, commands to fly the networked drone 100 to a specified location, commands to change altitude of the networked drone 100, commands to return the networked drone 100 to a landing pad, etc.

In one or more embodiments, the drone command 130 pertains to a telemetry function of the networked drone 100. Examples of telemetry functions include downloading data acquired by the networked drone 100, downloading status information pertaining to the networked drone 100, etc. Examples of downloading data include streaming down a live video acquired by the networked drone 100. Examples of status information include location data, motion data, communication logs, activity logs, command logs, etc.

In one or more embodiments, the drone command 130 pertains to a data acquisition function of the networked drone 100. Examples include commands to control one or more operating parameters of the data acquisition mechanism 108, e.g., gimbal controls, zoom controls, sampling modes, etc.

In one or more embodiments, the internet-connected device 120 runs a drone app that depicts downloaded information to a user of the internet-connected device 120 via, e.g., images, graphs, tables, charts, summaries, audio, video, etc., rendered using the built-in user interface mechanisms of the internet-connected device 120.

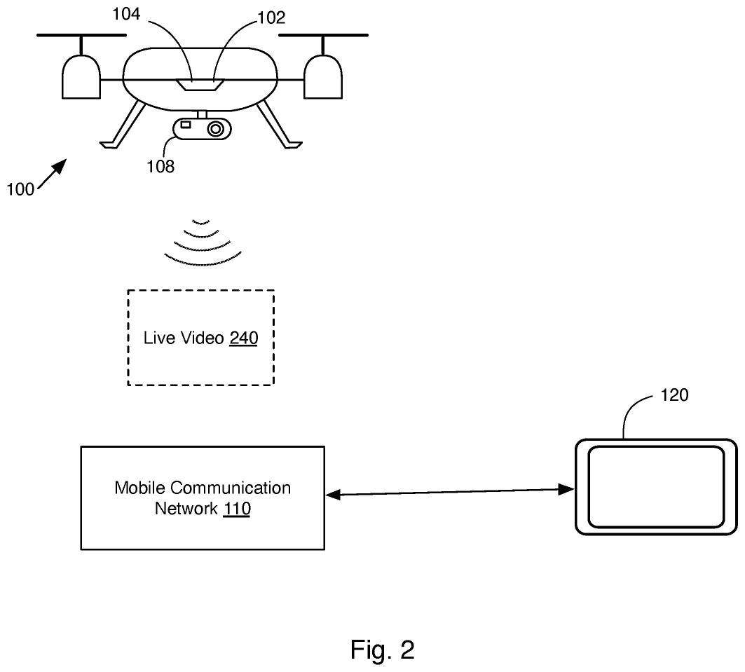

FIG. 2 shows an embodiment of the networked drone 100 that streams a live video 240 via the mobile communication network 110 using internet protocols. In this example, a user of the networked drone 100 views the live video 240 on the internet-connected device 120. In one or more embodiments, the networked drone 100 streams live video in real-time using WebRTC for direct communication between the networked drone 100 and the internet-connected device 120 via the mobile communication network 110 using, e.g., STUN TURN and ICE protocols, or other internet protocols.

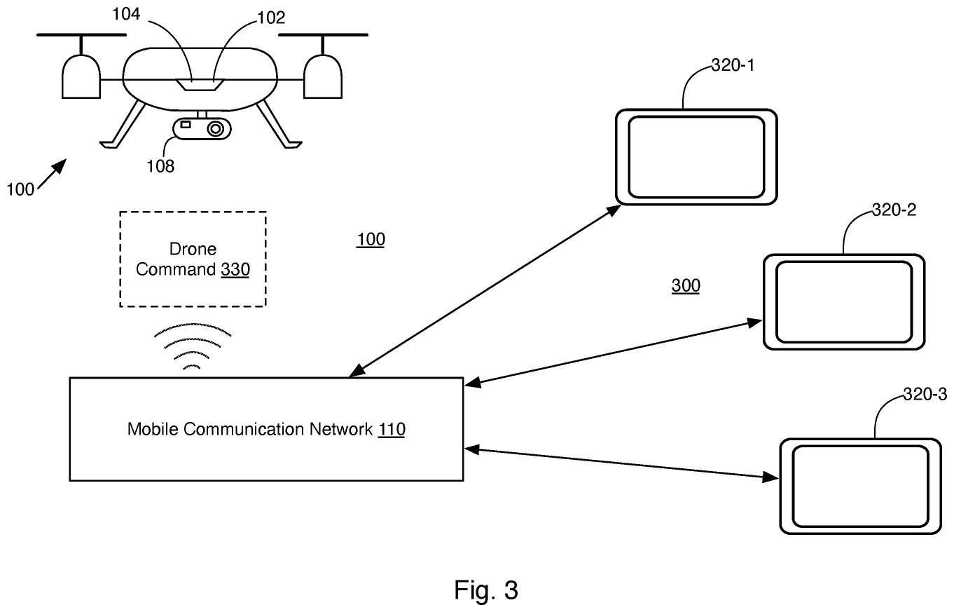

FIG. 3 shows an embodiment in which the command processor 102 actuates a function of the networked drone 100 in response to a drone command 330 received from a user who is a member of a constellation 300 of users who communicate with the networked drone 100 via the mobile communication network 110 using internet protocols. In one or more embodiments, the users in the constellation 300 command the networked drone 100 from a set of respective internet-connected devices 320-1 through 320-3.

There can be any number of internet-connected devices in the constellation 300 and any of the users in the constellation 300 can upload the drone command 330. The users in the constellation 300 can instigate any of the functions of the networked drone 100 by communicating with the networked drone 100 via the mobile communication network 110 using internet protocols. For example, one of the users in the constellation 300 can command the networked drone 100 to move to a particular geographic location and aim the data acquisition mechanism 108, etc., while another user or users in the constellation 300 commands the networked drone 100 to stream down a live video.

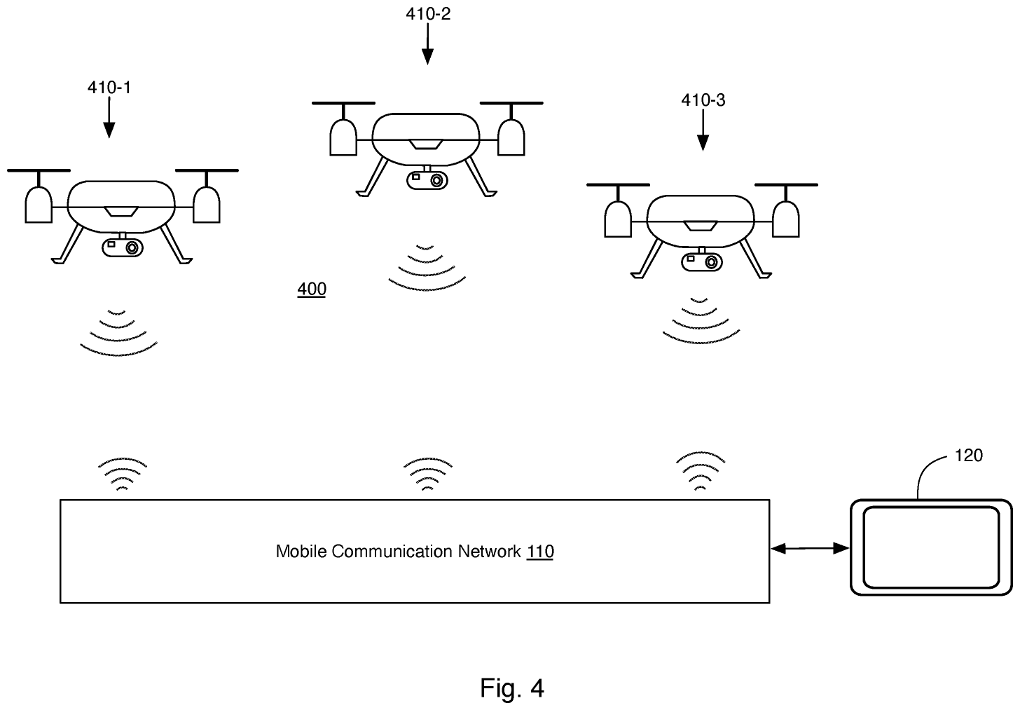

FIG. 4 shows a swarm 400 of networked drones 410-1 through 410-3 each having a respective network adapter for the mobile communication network 110. The networked drones 410-1 through 410-3 are controllable by a user via the mobile communication network 110, e.g., using the internet-connected device 120.

There can be any number of networked drones in the swarm 400. The swarm 400 can encompass any geographic disbursement. The user of the internet-connected device 120 can command any one or more of the networked drones in the swarm 400 by uploading drone commands via the mobile communication network 110 using internet protocols.

In one or more embodiments, the user of the internet-connected device 120 uploads drone commands to particular networked drones in the swarm 400 and those networked drones coordinate collective actions with other networked drones in the swarm 400 by communicating among the networked drones in the swarm 400 via the mobile communication network 110 using internet protocols. For example, a user can command the networked drone 410-1 to fly to a particular location and the networked drone 410-1 communicates with the networked drones 410-2 and 410-3 to coordinate flights to the particular location.

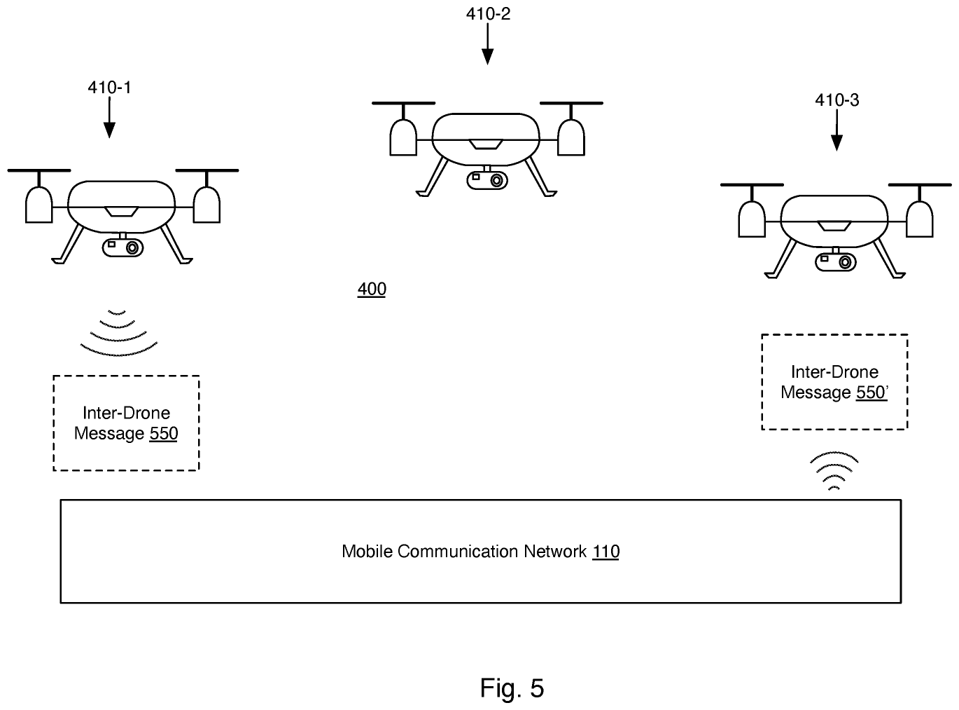

FIG. 5 shows an embodiment in which the networked drones 410-1 through 410-3 in the swarm 400 exchange inter-drone communications with one another via the mobile communication network 110 using internet protocols. For example, the networked drone 410-1 sends an inter-drone message 550 to the networked drone 410-3 via the mobile communication network 110. Any of the networked drones in the swarm 400 can exchange inter-drone communications with any of the other networked drones in the swarm 400 via the mobile communication network 110. In one or more embodiments, the networked drones 410-1 through 410-3 use inter-drone communications to share status information and adjust their missions accordingly, e.g., so they don't crash into each other.

Examples of inter-drone communications include telemetry, e.g., location, speed, altitude, heading, etc., drone mission parameters, e.g., final destination location, takeoff location, relative urgency of mission, e.g., when drones are used as first-responders, e.g., as a car crash on a highway, versus a potential false burglar alarm in a commercial building, etc., battery level, video quality, flight mode, e.g., en-route, hovering on location, stationary on the ground, circling around a destination, conducting a search and rescue grid search operation, delivering an item, etc.

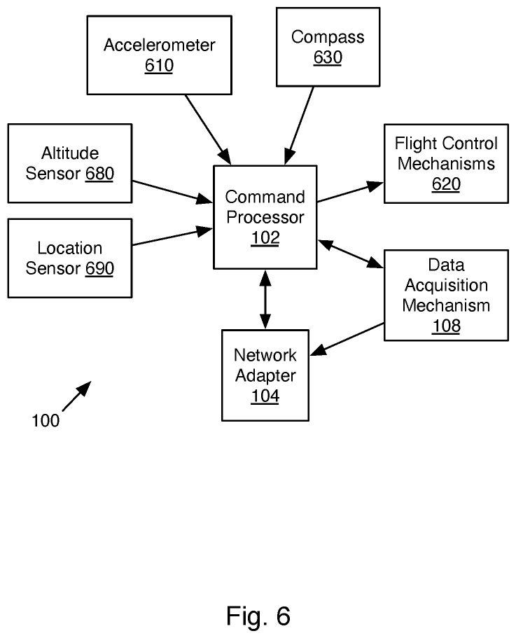

FIG. 6 illustrates how the command processor 102 in one or more embodiments obtains drone commands via the network adapter 104 and interprets and executes the drone commands and associated parameters contained therein.

For example, if a drone command specifies an altitude of X, then the command processor 102 reads the current altitude from an altitude sensor 680 and actuates a set of flight control mechanisms 620 to move the networked drone 100 to the specified altitude of X. Similarly, if a drone command specifies a location at GPS coordinates Y then the command processor 102 reads a current location from a location sensor 690, e.g., a GPS system, and actuates the flight control mechanisms 620 to move the networked drone 100 to the specified location Y. Likewise, the command processor 102 actuates the flight control mechanisms 620 to move the networked drone 100 in response to drone commands that reflect control inputs by the user of the networked drone 100 to move left, right, up, down, etc., via, e.g., a user interface implemented on the internet connected device 120. The command processor 102 in one or more embodiments uses information from an accelerometer 610 and a compass 630 to control the flight of the networked drone 100.

If a drone command pertains to the data acquisition mechanism 108, e.g., gimbal settings for pointing a camera, the command processor 102 actuates the data acquisition mechanism 108 accordingly. Likewise, the command processor 102 actuates the data acquisition mechanism 108 in response to commands for zooming in or out or for changing camera mode, e.g., between optical and infrared modes.

In one or more embodiments, the command processor 102 is implemented using a combination of processor resources and code.

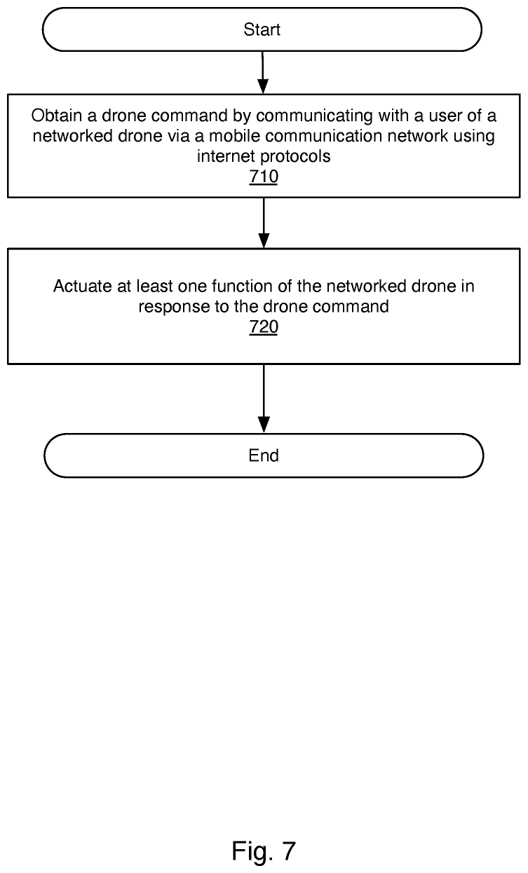

FIG. 7 illustrates a method for drone networking in one or more embodiments. While the various steps in this flowchart are presented and described sequentially, one of ordinary skill will appreciate that some or all of the steps can be executed in different orders and some or all of the steps can be executed in parallel. Further, in one or more embodiments, one or more of the steps described below can be omitted, repeated, and/or performed in a different order. Accordingly, the specific arrangement of steps shown in FIG. 7 should not be construed as limiting the scope of the invention.

At step 710, a drone command is obtained by communicating with a user of a networked drone via a mobile communication network using internet protocols. In one or more embodiments, the drone command is obtained from an internet-connected device of a user of the networked drone.

At step 720, at least one function of the networked drone is actuated in response to the drone command. The function can pertain to any aspect of the networked drone, e.g., flight functions, navigation, data acquisition functions, telemetry functions, multiple networked drone coordination functions, etc.

While the foregoing disclosure sets forth various embodiments using specific diagrams, flowcharts, and examples, each diagram component, flowchart step, operation, and/or component described and/or illustrated herein may be implemented, individually and/or collectively, using a range of processes and components.

The process parameters and sequence of steps described and/or illustrated herein are given by way of example only. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While the invention has been described with respect to a limited number of embodiments, those skilled in the art, having benefit of this disclosure, will appreciate that other embodiments may be devised which do not depart from the scope of the invention as disclosed herein.

What is claimed is:

1. A networked drone, comprising:
a command processor that actuates at least one function of the networked drone in response to a drone command; and
a network adapter that obtains the drone command by communicating with a user of the networked drone via a mobile communication network using internet protocols.

2. The networked drone of claim 1, wherein the drone command pertains to a navigation function of the networked drone.

3. The networked drone of claim 1, wherein the drone command pertains to a telemetry function of the networked drone.

4. The networked drone of claim 1, wherein the drone command pertains to a data acquisition function of the networked drone.

5. The networked drone of claim 1, wherein the drone command causes the networked drone to stream a live video acquired by the networked drone down to the user via the mobile communication network using internet protocols.

6. The networked drone of claim 1, wherein the command processor actuates a respective function of the networked drone in response to a respective drone command received from a respective user of a constellation of users who communicate with the networked drone via the mobile communication network using internet protocols.

7. The networked drone of claim 1, wherein the networked drone is a member of a swarm of networked drones each having a respective network adapter for the mobile communication network such that the user operates the swarm by providing a drone command to at least one of the members of the swarm via the mobile communication network using internet protocols.

8. The networked drone of claim 1, wherein the networked drone is a member of a swarm of networked drones each having a respective network adapter for the mobile communication network such that at least two of the members of the swarm exchange at least one inter-drone communication via the mobile communication network using internet protocols.

9. The networked drone of claim 8, wherein one or more of the networked drones in the swarm adjust a respective drone function in response to the inter-drone communication.

10. A method for drone networking, comprising:
obtaining a drone command by communicating with a user of a networked drone via a mobile communication network using internet protocols; and
actuating at least one function of the networked drone in response to the drone command.

11. The method of claim 10, wherein obtaining a drone command comprises obtaining a drone command pertaining to a navigation function of the networked drone.

12. The method of claim 10, wherein obtaining a drone command comprises obtaining a drone command pertaining to a telemetry function of the networked drone.

13. The method of claim 10, wherein obtaining a drone command comprises obtaining a drone command pertaining to a data acquisition function of the networked drone.

14. The method of claim 10, wherein actuating comprises streaming a live video acquired by the networked drone down to the user via the mobile communication network using internet protocols.

15. The method of claim 10, further comprising actuating a respective function in response to a respective drone command received from a respective user of a constellation of users who communicate with the networked drone via the mobile communication network using internet protocols.

16. The method of claim 10, further comprising operating a swarm of networked drones by providing a drone command to at least one of the members of the swarm via the mobile communication network using internet protocols.

17. The method of claim 16, further comprising exchanging at least one inter-drone communication among the swarm via the mobile communication network using internet protocols.

18. The method of claim 17, further comprising adjusting a respective function of at least one of the networked drones in the swarm in response to the inter-drone communication.
